(19) United States
(12) Patent Application Publication
(10) Pub. No.: US 2013/0279492 A1
(43) Pub. Date: Oct. 24, 2013

(54) MULTICARRIER PACKET SYNCHRONISATION

(71) Applicant: Mehul Mehta, Bristol (GB)

(72) Inventor: Mehul Mehta, Bristol (GB)

(21) Appl. No.: 13/880,538

(22) PCT Filed: Oct. 20, 2011
(86) PCT No.: PCT/GB2011/052039

§ 371 Date: May 29, 2013

(30) Foreign Application Priority Data
Oct. 21, 2010 (GB) 1017733.5

(51) Int. Cl. H04W 56/00

(52) U.S. Cl. CPC H04W 56/00
USPC 370/350

(57) ABSTRACT

One embodiment of the present invention provides a computationally efficient method to process a short training sequence in order to establish the presence of a valid packet on the medium and determine optimum sampling instance.

The present invention relates to wireless communications systems, and in particular to packet-based communications systems.

### BACKGROUND OF THE INVENTION

An exemplary wireless communications system is illustrated in FIG. 1 of the accompanying drawings. In such a system, a wireless communications network infrastructure 1 communicates via a radio frequency air interface 3 with a wireless communications device 5. The device 5 operates as a transmit station and as a receive station, and sends and receives data to and from the network infrastructure 1 in order to communicate with other devices. The representation of the network infrastructure 1 in FIG. 1 is schematic, and the infrastructure 1 may provide a point-to-point service that connects two devices, a local area network, a wide area network, or be part of a larger telecommunications system.

One technique for sending data between the device 5 and the infrastructure 1 is a so-called “packet based” technique in which data for transmission is divided into a stream of data packets or “frames” before being transmitted over the air interface. At the receiver, received data packets are recombined to reproduce the original data.

Frame synchronization is a critical part of the reception process in such a wireless packet network. The objective for the receive station is to determine if a valid packet is available on the transmission medium (the air interface), and, if so, to establish an optimum sampling instance in order to detect and demodulate successfully the contents of the packet.

In order to enable this process, a wireless packet network's physical layer frame structure includes a predefined training preamble for each data packet. Typically (see FIG. 2 of the accompanying drawings), a data packet 7 includes a preamble consisting of a two training sequences 72 and 74 to help the receiving station identify the presence of a valid packet. The precise structure of such a preamble differs from one standard to another, but essentially, it consists of two parts, as described below:
1. Short Training Sequence (STS) 72—several repetitions of a pre-defined training sequence (e.g., IEEE 802.15.3c OFDM mode uses a Golay sequence) whose statistical properties are known a priori. Typically, the purpose of the STS is to determine the presence of a valid packet on the medium, establish sample timing (start of packet, SOP), trigger an automatic gain control (AGC) loop. As shown in FIG. 2, the preamble includes N successive copies of the STS.
2. Long Training Sequence (LTS) 74—The STS is followed by another training sequence of different repetition and different statistical properties. Typically, the purpose of the LTS is to determine the channel impulse response (CIR) necessary to demodulate the rest of the packet. Both of these parameters need to be known in order to demodulate the payload of the packet and, hence successfully receive data packets from the network infrastructure.

A carrier frequency offset estimate can then be calculated using the preamble and its STS and LTS sequences.

A typical STS process at the receiver station includes two correlation functions:
1. Auto-correlation—the received signal is correlated continually with a delayed copy of itself. The equation (eqn. 1) below represents this process:

$${A}_{rr} = \vert {\sum }_{i = 0}^{M - 1} {r}_{i} \cdot {r}_{i + L} \vert \qquad eqn 1$$

where L=length of each STS, typically 128 as in IEEE 802.15.3c, and M is the size of the accumulator window, typically equal to the length of the STS.
2. Cross-correlation—the received signal is correlated continually with a stored copy of the STS. The equation below represents this process,

$${C}_{rs} = \vert {\sum }_{i = 0}^{M - 1} {r}_{i} \cdot {s}_{i} \vert \qquad eqn 2$$

where s is an ideal STS.

For a baseband equivalent received signal in a typical frequency selective multipath fading channel, can be represented as follows:

r(t)=s(t)*c(t)+n(t) eqn 3

where c(t) is the multipath channel impulse response that is convolved with the transmit signal s(t) and n(t) is additive white gaussian noise (AWGN).

Typically, the output of the auto-correlator is fed into a simple energy detection algorithm. Here, if the auto-correlation magnitude is above a predefined threshold then a valid signal (of the type shown in FIG. 2) is deemed to be present. Then, an automatic gain control (AGC) loop is triggered in order to increase the gain in the radio frequency (RF) and baseband sub-systems so that the rest of the signal is received with sufficient amplitude (signal to noise ratio, SNR). At the same time, the output of the cross-correlator is fed into another detection algorithm to determine optimum sampling. If the received signal is valid, then its packet structure (FIG. 2) consists of N repetitions of the STS and consequently the cross-correlator output shall yield N peak values. The cross-correlator detector uses this characteristic profile to determine the position of the first STS in the sequence and eventually establish optimum sampling. It is vital to do so in order to yield desired demodulation performance. Both the auto and cross correlation functions run continually until a valid output from both correlators is observed. This results in a large computational burden on the receiver throughout its operation cycle. In addition, there may not be a valid signal on the medium, or the SNR may be poor such that a false alarm occurs. Yet both correlators are required to be kept running and their outputs continually analyzed by their appropriate detectors.

Further, the presence of multipath channel, c(t), and noise, n(t) introduces additional challenges to the detection algorithms for both the correlator outputs. The cross correlator output in a multipath environment yields repeated CIR for each STS superimposed on top of the self correlation magnitude of each STS. However, realistic noise and multipath conditions causes the auto and cross correlator outputs to suffer from large degradation, and hence the respective detectors have to be suitably sophisticated and complex. For example, the cross-correlator outputs in low SNR do not clearly show the channel impulse response peaks. Instead, the peaks are buried in noise. Consequently, the combination of two detectors and two correlators puts huge computational burden on the receiver and is an implementation design challenge. Also, such large computational requirements result in a large gate count (and hence an increased power consumption) for the respective portion of the ASIC (application specific integrated circuit).

### SUMMARY OF THE INVENTION

Accordingly, embodiments of the present invention serve to improve the preamble processing in order to reduce the computation requirements, and thus reduce power consumption.

One embodiment of the present invention provides a computationally efficient method to process the STS in order to establish the presence of a valid packet on the medium and determine optimum sampling instance. In such an embodiment, the Automatic Gain Control (AGC) of the receiver is triggered early in order to ensure that the signal received has a desired signal to noise ratio which is within the dynamic range of subsequent processing modules, such as analogue to digital converters. Having a desired signal to noise ratio enables accurate processing and detection of the LTS.

In order to address this design challenge and achieve a desired high detection performance, embodiments of the present invention use only the cross-correlator and remove the auto-correlation function all together. The cross-correlator output is used for several purposes, including determining presence of a valid packet, scheduling AGC, establishing sample timing and coarse CFO estimate. It does all these within the time period of the STS portion of the preamble.

According to one aspect of the present invention, there is provided a method of processing a received training sequence of data values in a packet-based wireless communications system, the method comprising cross-correlating a received training sequence with a stored training sequence to produce a correlator output having a plurality of samples, determining a first start-of-packet estimate using a first series of samples of the correlator output, performing an automatic gain control process to determine a desired gain value, following determination of a desired gain value, determining a second start-of-packet estimate using a second series of samples of the correlator output, and determining a first carrier frequency offset estimate in advance of the determination of the second start-of-packet estimate.

In one example, the automatic gain control process uses a third series of samples of the correlator output, the third series being subsequent to the first series.

In one example, determining the first carrier frequency offset estimate uses a fourth series of samples of the correlator output, the fourth series being subsequent to the second series.

In one example determining a first start-of-packet estimate includes filtering the correlator output to remove high frequency noise before the first start-of-packet estimate is determined.

The received training sequence may be a short training sequence contained in a preamble of a data packet.

One example includes, following determination of a carrier frequency offset, determining a channel impulse response estimate and a second channel frequency offset estimate using the second start-of-packet estimate, the desired gain value, the first carrier offset estimate, and a long training sequence portion of the preamble of the data packet.

One example includes reverting to cross-correlating a received training sequence in the event that the desired gain value, second start-of-packet estimate, or first channel frequency offset estimate is unobtainable, or inadequate.

According to another aspect of the present invention, there is provided a device for carrying out such methods.

According to another aspect of the present invention, there is provided a device for processing a received training sequence of data values in a packet-based wireless communications system, the device comprising a cross-correlator operable to cross-correlate a received training sequence with a stored training sequence to produce a correlator output having a plurality of samples, a start-of-packet module operable to determine a first start-of-packet estimate using a first series of samples of the correlator output, an automatic gain control module operable to perform an automatic gain control process for determining a desired gain value, a reliable start-of-packet module operable to determine, following determination of a desired gain value by the automatic gain control module, a second start-of-packet estimate using a second series of samples of the correlator output, and an offset module operable to determine a first carrier frequency offset estimate in advance of determination of a second start-of-packet estimate by the reliable start-of-packet module.

The automatic gain control module may be operable to use a third series of samples of the correlator output, the third series being subsequent to the first series.

The offset module may be operable to use a fourth series of samples of the correlator output, the fourth series being subsequent to the second series.

Such a device may further comprise a filter operable to filter such a correlator output to remove high frequency noise before a first start-of-packet estimate is determined.

The received training sequence may be a short training sequence contained in a preamble of a data packet.

Such a device may further comprise a long training sequence module operable to determine a channel impulse response estimate and a second channel frequency offset estimate using a second start-of-packet estimate received from the reliable start-of-packet module, a desired gain value received from the automatic gain control module, a first carrier offset estimate received from the offset module, and a long training sequence portion of the preamble of a received data packet.

Such a device may further comprise a control module operable to control the cross-correlator, the start-of-packet module, the automatic gain control module, the reliable start-of-packet module and the offset module.

The control module may be operable to cause the device to revert to determination of the first start-of-packet estimate in the event that the desired gain value, second start-of-packet estimate, or first channel frequency offset estimate is unobtainable, or inadequate.

### BRIEF DESCRIPTION OF THE DRAWINGS

FIG. 1 illustrates schematically a wireless communications system;

FIG. 2 illustrates schematically a data packet structure;

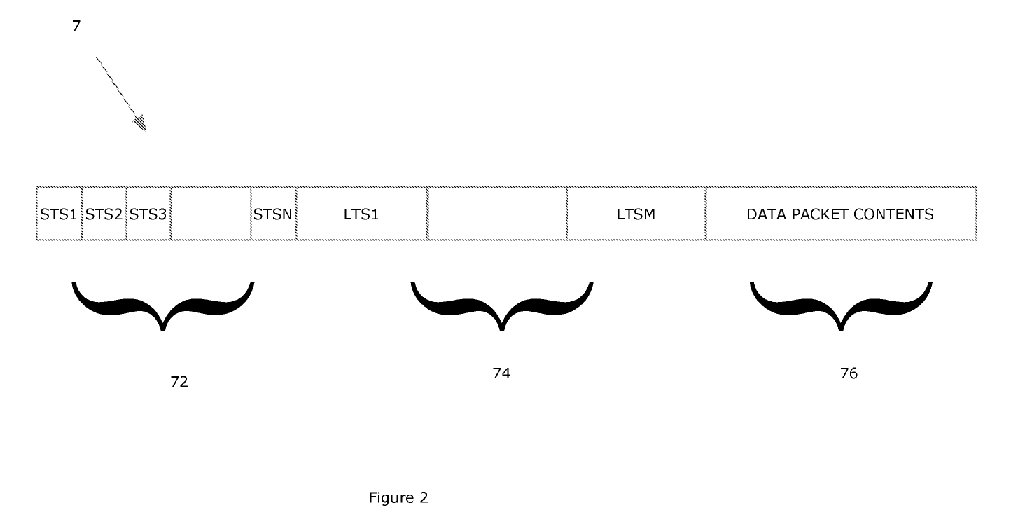

FIG. 3 illustrates schematically a wireless device embodying one aspect of the present invention; and

FIG. 4 is a flow chart illustrating a method embodying another aspect of the present invention.

### DETAILED DESCRIPTION OF THE PREFERRED EMBODIMENTS

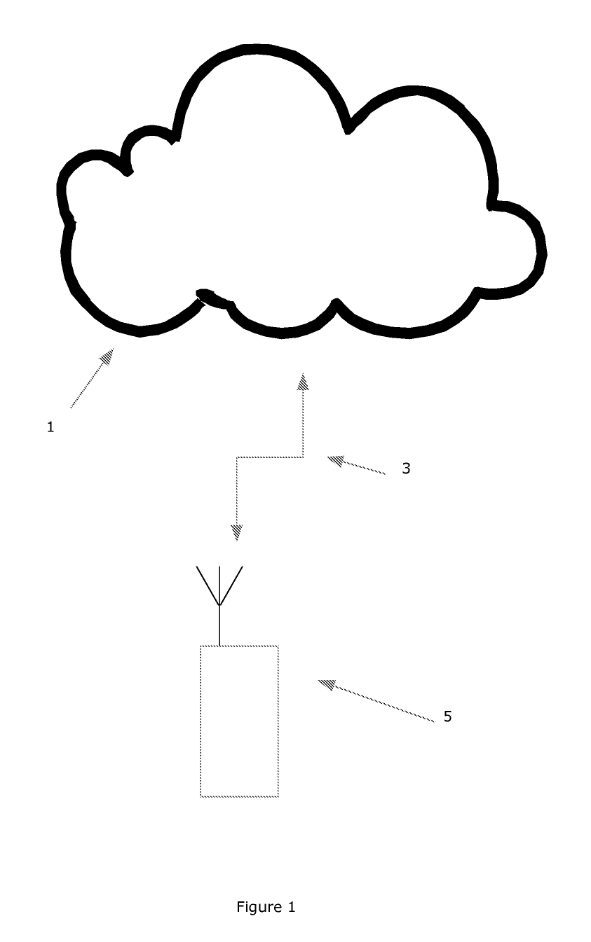

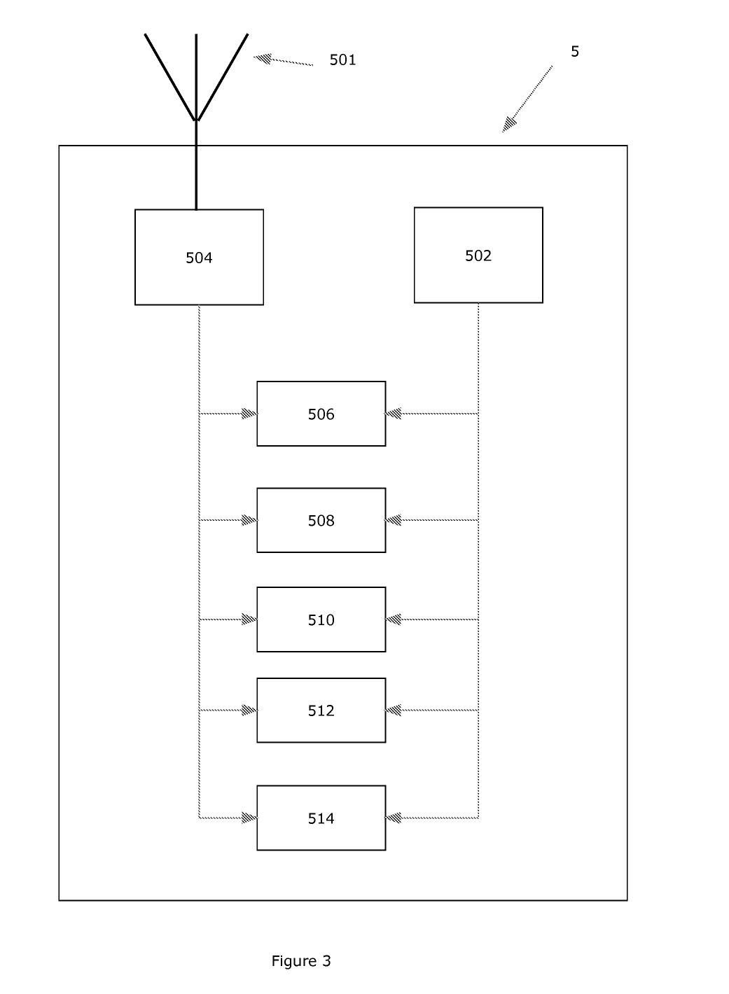

FIG. 3 shows a wireless communications device 5 embodying one aspect of the present invention and suitable for use in the system as shown in, and described with reference to, FIG. 1. The device 5 includes an antenna 502 for transmission and reception of radio frequency signals in accordance with known techniques. The device also includes a control module 504 which controls the operation of the device 5. The important functions of the device 5 are illustrated by individual modules in FIG. 3, and will be explained in more detail below. As will readily be appreciated, the modules' respective functionalities may be provided in any appropriate manner, using hardware, software, or a suitable combination of the two. In addition, it will be readily appreciated that the functionalities may be provided by the control module, or any other module. For the sake of clarity, only functions directly relevant to the embodiments of the present invention are shown explicitly in FIG. 3. Functions such as data input and storage, encoding and decoding, and input/output can be provided in line with known techniques as necessary, for example by the control module 504.

The device shown in FIG. 3 includes functionality for dealing with STS and LTS in the preamble of an incoming data packet. Since embodiments of the present invention are concerned with STS processing, the LTS functionality is shown only as a LTS module 514. The STS functionality is provided by a filter and coarse-SOP module 506, an automatic gain control module 508, a reliable-SOP module 510, and a coarse-CFO module 512. The modules are under the control of the control module 504, and operate as describe below.

A method embodying the present invention cross-correlates continually a received signal with a stored STS, in order to produce a correlator output which comprises a stream of samples. One of the key aspects of this approach is to prioritize the AGC ahead of establishing optimum sampling. This is contrary to common techniques wherein one of the first tasks of the STS preamble processing is to establish sample timing.

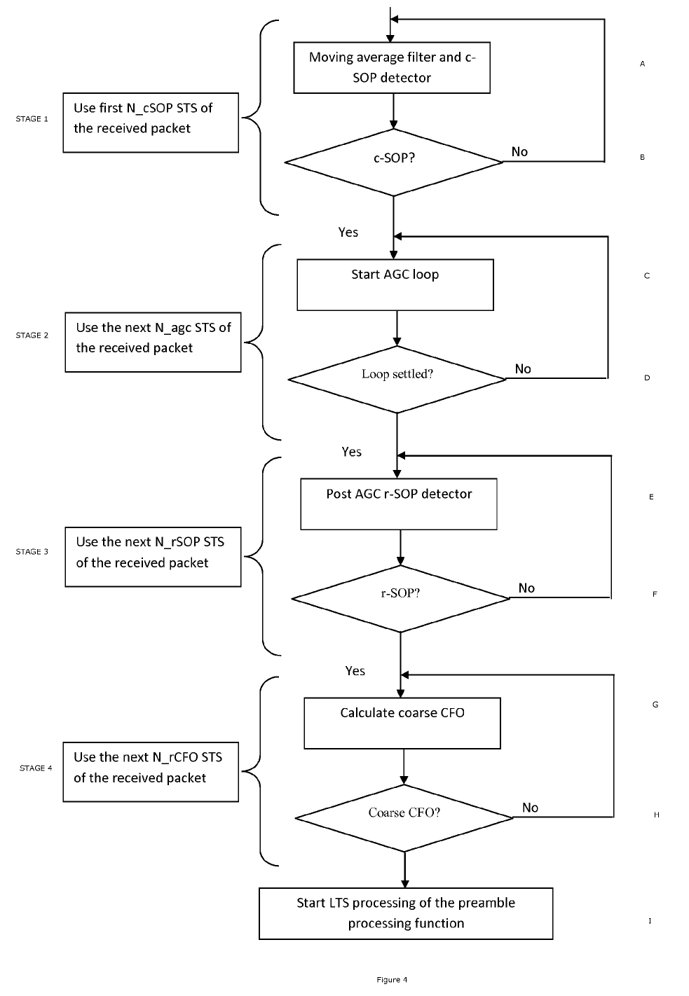

An example of such a method will be described with reference to the block diagram of FIG. 3, and the flowchart of FIG. 4.

The cross-correlator output is provided to the filter and coarse-SOP module 506, which detects the presence of a valid packet and determines a first start of packet (SOP) estimate (stage 1; steps A and B). It is common that there is no signal on the air interface prior to the first sample of the first STS of the received data packet. Accordingly, during stage 1, the filter and coarse-SOP module 506 performs continually a moving average filtering operation. The size of this filter 506 is equal to N (length of one of the STS). The frequency response of the moving average filter 506 is a function of the maximum delay spread tolerance for which the system is calibrated. In other words, the frequency response of the moving average filter 506 is a function of the observable coherence bandwidth. This filter 506 is not adaptive. The purpose of this moving average filter is to remove the high frequency noise from the CIR so that the wanted signal energy is then be analyzed by a coarse-SOP detector of the filter and coarse-SOP module 506. The coarse-SOP detector takes in the noise smoothed cross-correlator output to seek out the dominant multipath peak of the CIR. It is not necessary to seek out the first multipath tap, as it is only necessary at this stage to establish the presence of a packet. Successive STS are deemed to have been received once the presence of the dominant multipath peak is detected at periodic intervals over a first series of N_cSOP samples. The period between these successive peaks is roughly equal to the length of one STS.

In the present example, when this first, coarse, SOP estimate has been determined, the method moves to performing automatic gain control (AGC) using the automatic gain control module 508 (stage 2; steps C and D), in order to increase the SNR of the detected signal, so that it is suitable for further processing. This AGC stage makes use of a second series N_agc of cross-correlator samples, subsequent to the first series used for coarse-SOP detection in stage 1.

When the AGC has settled, the reliable-SOP module 510 operates to perform stage 3 of the process (steps E and F) in which a third series of N_rSOP cross-correlator output samples is used to determine a second, reliable, SOP estimate. The third series of cross-correlator output samples is subsequent to the second series.

It will be readily appreciated that the AGC process need not wait for completion of the coarse SOP estimate to be completed before running. In embodiments of the present invention, all that is required is that the AGC process has run before the reliable SOP estimate is determined.

Stage 4 of the method comprises determination of a coarse carrier frequency offset (CFO) estimate by the coarse-CFO module 512 (steps G and H). In this example, this stage of the method uses a fourth series of N_rCFO cross-correlator output sample, subsequent to the third series. Once again, it will be readily appreciated that the CFO estimate can be determined at anytime during the STS processing, and that the only requirement is for the coarse CFO estimate to be determined by the time the reliable SOP estimate has been determined,

Following determination of a coarse carrier frequency offset estimate, the STS processing method is at an end, and the training process moves to LTS processing (step I), using the LTS module 514. The LTS processing will not be described in detail here for the sake of clarity.

In this method, it is possible to revise sample timing more than once throughout the STS processing time-line, without compromising overall performance. At any stage in the method, if the processing results are inadequate or inconsistent, processing can revert to stage 1, the detection of the presence of a data packet and the determination of a first SOP estimate. For example, if, after the AGC loop has settled, successive correlator outputs do not show the presence of the characteristic CIR peaks, then the method may revert back to stage 1, that is seeking presence of valid packet and determining a first SOP estimate.

Each stage of the method consumes a fixed amount of STS of the received packet. The total number of short training sequences used for each stage is less than or equal N, the total number of STS present in a valid packet.

It will, therefore, be appreciated that embodiments of the present invention provide techniques that enable reliable frame synchronisation in a wireless data packet based system, with reduced computation requirements compared with previously considered solutions.

It will also be appreciated that the techniques described are applicable to any packet-based wireless system, and in particular to wireless systems that require high data rates and low power consumption

1-17. (canceled)

18. A method of processing a received training sequence of data values in a packet-based wireless communications system, the method comprising:
cross-correlating a received training sequence with a stored training sequence to produce a correlator output having a plurality of samples;
determining a first start-of-packet estimate using a first series of samples of the correlator output;
performing an automatic gain control process to determine a desired gain value;
following determination of a desired gain value, determining a second start-of-packet estimate using a second series of samples of the correlator output; and
determining a first carrier frequency offset estimate in advance of the determination of the second start-of-packet estimate.

19. The method as claimed in claim 18, wherein the automatic gain control process uses a third series of samples of the correlator output, the third series being subsequent to the first series.

20. The method as claimed in claim 18, wherein determining the first carrier frequency offset estimate uses a fourth series of samples of the correlator output, the fourth series being subsequent to the second series.

21. The method as claimed in claim 18, wherein the determining a first start-of-packet estimate includes filtering the correlator output to remove high frequency noise before the first start-of-packet estimate is determined.

22. The method as claimed in claim 18, wherein the received training sequence is a short training sequence contained in a preamble of a data packet.

23. The method as claimed in claim 18, further comprising, following determination of a carrier frequency offset, determining a channel impulse response estimate and a second channel frequency offset estimate using the second start-of-packet estimate, the desired gain value, the first carrier offset estimate, and a long training sequence portion of the preamble of the data packet.

24. The method as claimed in claim 18, further comprising reverting to cross-correlating a received training sequence in the event that the desired gain value, second start-of-packet estimate, or first channel frequency offset estimate is unobtainable, or inadequate.

25. A device for processing a received training sequence of data values in a packet-based wireless communications system, the device comprising:
a cross-correlator operable to cross-correlate a received training sequence with a stored training sequence to produce a correlator output having a plurality of samples;
a start-of-packet module operable to determine a first start-of-packet estimate using a first series of samples of the correlator output;
an automatic gain control module operable to perform an automatic gain control process for determining a desired gain value;
a reliable start-of-packet module operable to determine, following determination of a desired gain value by the automatic gain control module, a second start-of-packet estimate using a second series of samples of the correlator output; and
an offset module operable to determine a first carrier frequency offset estimate in advance of determination of a second start-of-packet estimate by the reliable start-of-packet module.

26. The device as claimed in claim 25, wherein the automatic gain control module is operable to use a third series of samples of the correlator output, the third series being subsequent to the first series.

27. The device as claimed in claim 25, wherein the offset module is operable to use a fourth series of samples of the correlator output, the fourth series being subsequent to the second series.

28. The device as claimed in claim 25, further comprising a filter operable to filter such a correlator output to remove high frequency noise before a first start-of-packet estimate is determined.

29. The device as claimed in claim 25, wherein the received training sequence is a short training sequence contained in a preamble of a data packet.

30. The device as claimed in claim 25, further comprising a long training sequence module operable to determine a channel impulse response estimate and a second channel frequency offset estimate using a second start-of-packet estimate received from the reliable start-of-packet module, a desired gain value received from the automatic gain control module, a first carrier offset estimate received from the offset module, and a long training sequence portion of the preamble of a received data packet.

31. The device as claimed in claim 25, further comprising a control module operable to control the cross-correlator, the start-of-packet module, the automatic gain control module, the reliable start-of-packet module and the offset module.

32. The device as claimed in claim 25, further comprising a control module operable to control the cross-correlator, the start-of-packet module, the automatic gain control module, the reliable start-of-packet module and the offset module, wherein the control module is operable to cause the device to revert to determination of the first start-of-packet estimate in the event that the desired gain value, second start-of-packet estimate, or first channel frequency offset estimate is unobtainable, or inadequate.
